(19) United States
(12) Patent Application Publication
(10) Pub. No.: US 2026/0211917 A1
(43) Pub. Date: Jul. 23, 2026

(54) CONTEXT DATA RETRIEVAL USING IMPLICIT TERMS

(71) Applicant: Dell Products L.P., Round Rock, TX (US)

(72) Inventors: OFIR EZRIELEV, Be'er Sheva (IL); LEV MAKLER, Be'er Sheva (IL); YEHONATAN COHEN, Ashdod (IL)

(21) Appl. No.: 19/034,851

(22) Filed: Jan. 23, 2025

(51) Int. Cl. G06F 16/334; G06F 16/36

(52) U.S. Cl. CPC G06F 16/334; G06F 16/367

(57) ABSTRACT

Methods and systems for managing operation of a data processing system are disclosed. A portion of ontology terms specified by ontology definitions for which instances of the portion of the ontology terms are present in a prompt may be identified. Based on a representation of the portion of the ontology terms, supplemental ontology terms related to the portion of the ontology terms, wherein an instance of any of the supplemental ontology terms is not present in the prompt, may be identified. A query may be obtained based on the portion of the ontology terms and the supplemental ontology terms. A retrieval process for the prompt may be performed using the query to obtain context data. A response may be obtained from a trained generative machine-learning model using the prompt and the context data. The response may be used to provision desired computer-implemented services.

### FIELD

Embodiments disclosed herein relate generally to managing data processing systems. More particularly, embodiments disclosed herein relate to systems and methods to manage operation of the data processing systems using inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIGS. 2A-2C show data flow diagrams in accordance with an embodiment.

FIG. 2D shows a diagram illustrating an example of a representation in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems that may provide computer-implemented services. The computer-implemented services may be provided using inference models (e.g., artificial intelligence models). The inference models may be used to generate inferences regarding operation of the data processing systems, and the inferences may be used in downstream processes to increase a likelihood of desired operation of the data processing systems. For example, the inference models may be trained to infer information regarding occurrences of security events (e.g., security threats) to the data processing systems based on ingest data, and the operation of the data processing systems may be updated to mitigate (e.g., prevent) negative outcomes associated with the security events.

However, a quality (e.g., reliability) of the inferences used to manage the operation of the data processing systems may depend on a quality (e.g., informational content) of the ingest data provided to the (trained) inference models to obtain the inferences. For example, the ingest data may include a prompt (e.g., input from a downstream consumer of the inferences). If the informational content of the prompt is limited and/or ambiguous, then the ingest data to the inference model may be inadequate for generating an inference of expected quality.

To increase a likelihood of generating an inference of expected quality, a retrieval-augmented generation process may be implemented. During the retrieval-augmented generation process, context data (e.g., additional information regarding terms such as words and/or phrases in the prompt) may be retrieved from a trusted knowledge base during a retrieval process. The context data may then be used to increase the informational content of the ingest data provided to the inference models to generate the inference.

However, due to limitations of the retrieval process, the context data may be insufficient to generate expected quality ingest data (e.g., ingest data with adequate informational content). For example, the retrieval process may rely on a list of search terms of a query for searching the trusted knowledge base. Therefore, if the query does not include sufficient or relevant search terms, then insufficient and/or irrelevant context data may be retrieved, which may reduce a quality of the ingest data to the inference models. Consequently, inferences generated by the inference models based on the ingest data may not be suitable for the downstream processes used to manage operation of the data processing systems.

Thus, to increase a likelihood of providing expected quality ingest data to the inference models, relevant terms may be identified based on prompts for the inference models, and may be used to form a query for the retrieval process. The retrieval process may be performed (e.g., iteratively) until sufficiency criteria for context data retrieved in response to the query is met. To do so, an ontology for use of the inference models may be defined. The ontology may include ontology definitions that specify a list of ontology terms (e.g., words and/or phrases) that have been designated as having a higher degree of meaning by an operator of the inference models than degrees of meaning of other terms.

The relevant terms may include ontology terms specified by the ontology definitions for which instances of the ontology terms are present in the prompts (e.g., ontology terms explicitly included in the prompt), as well as supplemental ontology terms specified by the ontology definitions that are related to those identified as present in the prompt (e.g., ontology terms implicitly included in the prompt). The relevant terms may be used (e.g., in the form of a query) to perform the retrieval processes, and the retrieval processes may be performed until context data for each of the relevant ontology terms meets the sufficiency criteria.

By doing so, context data obtained during retrieval processes may be more likely to be sufficient and relevant for improving a quality of the ingest data to the inference models, thereby improving a quality of the inferences used to manage operation of the data processing systems.

In an embodiment, a method for managing operation of a data processing system is provided. The method may include: identifying a portion of ontology terms specified by ontology definitions for which instances of the portion of the ontology terms are present in a prompt; identifying, based on a representation of the portion of the ontology terms, supplemental ontology terms related to the portion of the ontology terms, wherein an instance of any of the supplemental ontology terms is not present in the prompt; obtaining a query based on the portion of the ontology terms and the supplemental ontology terms; performing, using the query, a retrieval process for the prompt to obtain context data; obtaining a response from a trained generative machine-learning model using the prompt and the context data; and, using the response to provision desired computer-implemented services.

The prompt may be a submission to be processed by the trained generative machine-learning model to facilitate provisioning of the desired computer-implemented services.

The representation of the portion of the ontology terms may include an acyclic graph, the acyclic graph including a plurality of nodes connected by a plurality of edges, the plurality of nodes representing the portion of the ontology terms and at least the supplemental ontology terms, and the plurality of edges representing relationships between the nodes.

Identifying the supplemental ontology terms may include: identifying a first node of the acyclic graph that corresponds to an ontology term of the portion of the ontology terms; obtaining a number of related nodes of the acyclic graph, the related nodes being connected to the first node, and each of the related nodes corresponding to a related ontology term specified by the ontology definitions for which an instance of which is not present in the prompt; and, characterizing the ontology term based on the number of the related nodes and at least one threshold.

Identifying the supplemental ontology terms may further include obtaining user input based on the related nodes, the user input indicating selection of the supplemental ontology terms. Identifying the supplemental ontology terms may further include selecting all related ontology terms that correspond with the related nodes as the supplemental ontology terms.

Identifying the supplemental ontology terms may further include selecting no supplemental ontology terms.

The query may be serviced using a deterministic process, the deterministic process returning same results for repeated servicing of the query.

Performing the retrieval process may include: performing a first retrieval process for the prompt using the query to obtain first context data of the context data; making a determination regarding whether the first context data meets sufficiency criteria, the sufficiency criteria specifying a minimum level of content of the first context data with respect to the ontology definitions; and, in a first instance of the determination where the first context data does not meet the sufficiency criteria: identifying at least one ontology term of the portion of the ontology terms and the supplemental ontology terms for which the first context data does not meet the sufficiency criteria, and performing a second retrieval process for the prompt using a revised query that is based at least on the at least one ontology term to obtain second context data of the context data.

The ontology definitions may include a list of ontology terms including the portion of the ontology terms and the supplemental ontology terms, and the ontology terms specified by the ontology definitions may be words and/or phrases that have been designated as having a higher degree of meaning by an operator of the trained generative machine-learning model than other words and/or phrases not designated as having the higher degree of meaning by the operator.

The context data may be obtained from a data source designated as a source of true data by the operator of the trained generative machine-learning model, and the data source may include a number of chunks of data that are each tagged to associate each of the number of chunks of data with the ontology terms.

Using the response to provision the desired computer-implemented services may include updating the operation of the data processing system.

A non-transitory media may include instructions that when executed by a processor cause the computer-implemented method to be performed.

A system may include the non-transitory media and a processor, and may perform the computer-implemented method when the computer instructions are executed by the processor.

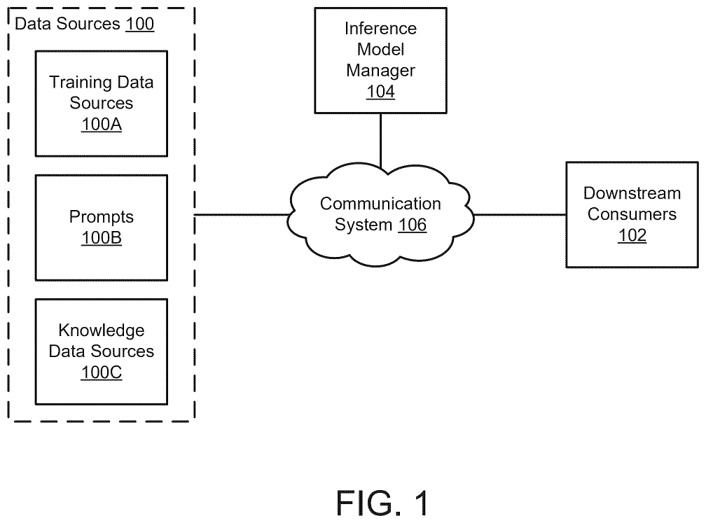

Turning to FIG. 1, a block diagram illustrating a distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device.

The computer-implemented services may be provided by data processing systems to consumers of the computer-implemented services (e.g., users of the data processing systems, other data processing systems). To provide the computer-implemented services, operation of the data processing systems may be managed, for example, in accordance with policies (e.g., security policies, acceptable use policies). The policies may be enforced via updates to the operation of the data processing system over time to increase a likelihood of providing desired (e.g., secure, reliable) computer-implemented services.

The operation of the data processing system may be managed using artificial intelligence. For example, (trained) inference models may be used to assess, predict, and/or otherwise manage occurrences of events that may negatively impact provisioning of the computer-implemented services as desired, such as security events that may threaten the security of the data processing system (e.g., sensitive data accessible using the data processing systems).

To do so, an inference model such as a generative machine-learning model may be trained to generate a response to (e.g., an inference based on) ingest data. For example, the ingest data may include information regarding programs being executed by components of a data processing system, and the inference model may be trained to identify, based on the ingest data, a security threat to the data processing system and/or actions for managing the security threat. To manage the security threat, the inference may be provided to a downstream process during which operation of the data processing system may be updated in a manner that mitigates an undesired outcome of the security threat.

However, the responses obtained from the (trained) inference models may not be reliable for managing the operation of the data processing systems if informational content of the ingest data used during inferencing is inadequate. For example, terms (e.g., words and/or phrases) included in the prompt may be ambiguous and/or may have special meaning (e.g., a term may have different meaning to an operator of the inference models than a meaning based on its dictionary definition). Therefore, to increase a likelihood of generating reliable responses during inferencing, a retrieval-augmented generation process may be implemented to improve informational content of the ingest data to the inference models. To do so, the prompt may undergo preprocessing, during which context data may be obtained for terms present in the prompt.

For example, to obtain expected quality (e.g., adequate) ingest data, the prompt may be provided to a data pipeline. The data pipeline may include a retrieval process, during which terms in the prompt are identified and used to generate a query, and context data for the identified terms is obtained in response to the query. For example, during a query generation process, terms that may require context data may be identified as present in the prompt, and a list of the terms may be included in the query used by the retrieval process. The retrieval process may use methods to (i) identify portions of context data from a trusted data source based on the query, (ii) rank the identified portions of context data, and/or (iii) select a number of the ranked identified portions of context data for use as the context data.

However, due to limitations of the query generation process, the retrieved context data may be irrelevant and/or may lack desired detail (e.g., by a user of the inference model, by a generator of the prompt), and due to limitations of the retrieval process, context data may not be retrieved for all identified terms. For example, a prompt may include a complex term (e.g., a general term and/or a term that is related to a number of specific terms) that, when included in the query may result in the retrieval of (i) inappropriately detailed context data (e.g., overgeneralized context data), and/or (ii) a large volume of context data that includes irrelevant portions. If larger than necessary volumes of context data and/or inappropriately detailed context data are used to generate ingest data for an inference model, then performance of the inference model may be negatively affected, in terms of inference quality and/or consumption of computational resources.

Consequently, the context data may be insufficient for generating adequate ingest data. If the ingest data is inadequate, then a subsequent inferencing process that uses the inadequate ingest data may be likely to provide unreliable inferences, and outcomes of downstream processes (e.g., management processes for the data processing systems) that use the inferences may be undesirable.

In general, embodiments disclosed herein may provide methods, systems, and/or devices for managing operation of data processing systems using inference models in a manner that is more likely to result in desirable management outcomes. To do so, prompts for processing by the inference models may be preprocessed to obtain a query for a retrieval process using ontology definitions. The ontology definitions may be defined by an operator of the inference models and may include a list of ontology terms for which context data is to be retrieved when instances of the ontology terms are present in the prompt.

The query may be generated to include ontology terms relevant to the prompt. For example, the query may include (i) a portion of ontology terms specified by the ontology definitions identified as present in the prompt (e.g., explicitly stated ontology terms), and (ii) supplemental ontology terms specified by the ontology definitions that are related to the identified ontology terms, despite the supplemental ontology terms not being identified as present in the prompt (e.g., implicitly stated ontology terms). The supplemental ontology terms may be included in the query to increase a likelihood of retrieving relevant, appropriately detailed context data.

The query may be provided to an iterative retrieval process that continues to retrieve context data until the context data meets sufficiency criteria. For example, the sufficiency criteria may specify a minimum level of content of the context data with respect to the ontology definitions. The retrieval process may be performed iteratively until sufficient context data has been retrieved for each relevant ontology term included in the query (e.g., each supplemental ontology term and each ontology term identified as present in the prompt).

By doing so, the context data obtained during prompt preprocessing may be more likely to be relevant and sufficient for providing adequate ingest data to the inference models, thereby increasing a likelihood of the inferences being reliable for use in managing the operation of the data processing systems.

To provide the above-mentioned functionality, the distributed system of FIG. 1 may include data sources 100, downstream consumers 102, inference model manager 104, and communication system 106. The distributed system, any components thereof, and/or any other types of devices or components not shown in FIG. 1 may perform all, or a portion of the computer-implemented services independently and/or cooperatively. Each of these components is discussed below.

Data sources 100 may include any type and/or number of data sources. Each of data sources 100 may include hardware and/or software components configured to obtain data, store data, provide data to other entities, and/or to perform any other tasks to facilitate performance of computer-implemented services. Different data sources of data sources 100 may facilitate similar and/or different computer-implemented services. For example, data sources 100 may include training data sources 100A, prompts 100B, knowledge data sources 100C, and/or other sources of data usable to facilitate operation of inference models.

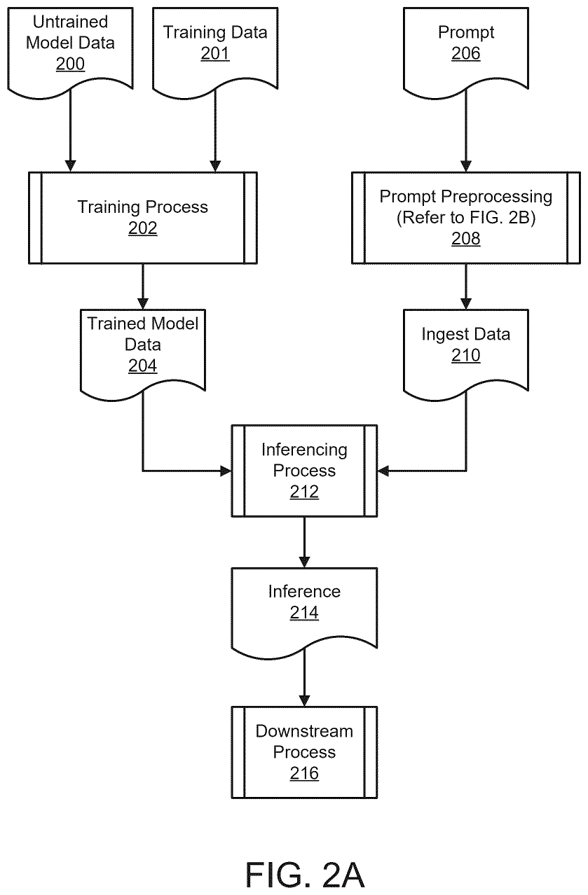

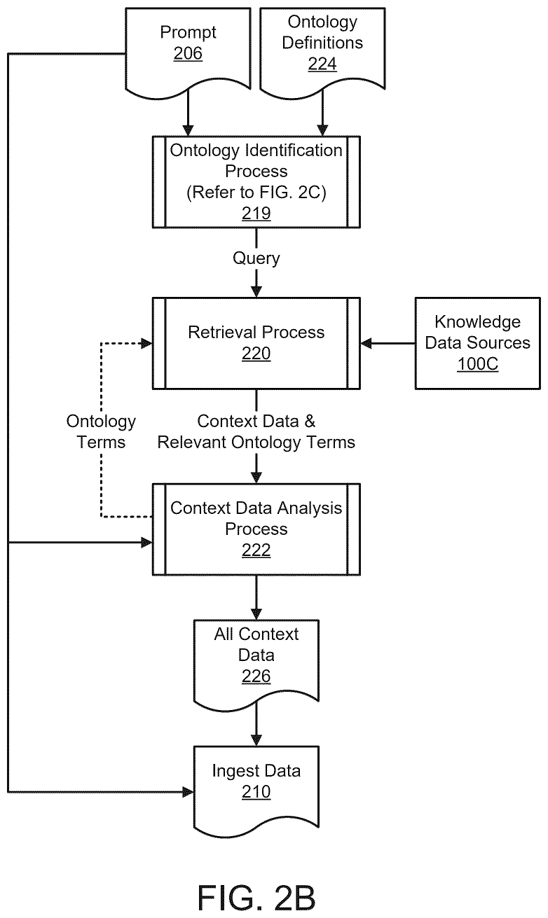

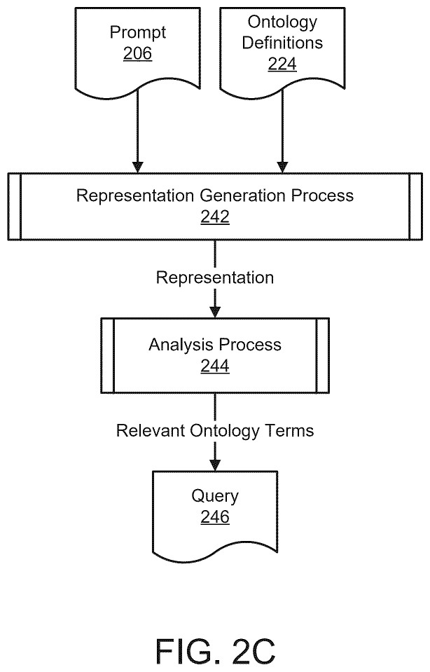

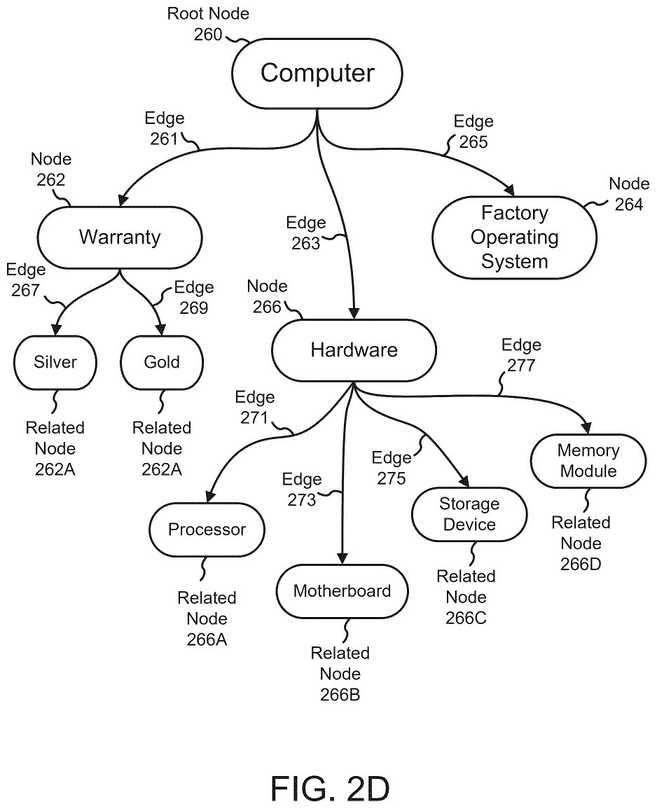

Training data sources 100A may include any number of data sources that provide training data for training of inference models. Training data sources 100A may include sources of raw data, processed data (e.g., curated data), and/or other types of data usable to train (e.g., retrain, fine-tune) the inference models. Refer to the discussion of FIG. 2A for more information regarding training of inference models.

Prompts 100B may include any volume and/or type of data for processing by the inference models. For example, prompts 100B may include any number of prompts obtained from consumers of inferences generated by the inference models (e.g., individuals, computers). Prompts 100B may include unstructured data and may be used, at least in part, to generate ingest data for inference models. For example, prompts 100B may include instances of ontology terms (e.g., complex ontology terms), and may undergo preprocessing to obtain sufficient context data for generating adequate ingest data. Refer to the discussion of FIGS. 2A-2C for more information regarding prompt preprocessing.

Knowledge data sources 100C may include any number and/or type of data sources that provide context data for prompts 100B. Knowledge data sources 100C may include a data source designated as a source of true data by an operator of inference models. Knowledge data sources 100C may be managed by the operator and/or another entity. For example, knowledge data sources 100C may include information regarding ontology terms included in ontology definitions defined by the operator and/or an organization of the operator, and may be queried during preprocessing of a prompt of prompts 100B (e.g., during a retrieval process). Refer to the discussion of FIG. 2B for more information regarding use of knowledge data sources 100C.

Data sources 100 may include data repositories (e.g., training data repositories and/or knowledge data repositories, not shown), and may provide data to (e.g., allow access to data by) inference model manager 104.

Downstream consumers 102 may include any number and/or type of downstream consumers. For example, downstream consumers 102 may include individuals, organizations, and/or computers. Downstream consumers 102 may consume all, or a portion of the computer-implemented services. For example, downstream consumers 102 may include users of the managed data processing systems.

Downstream consumers 102 may consume all, or a portion of the inferences and/or output from downstream processes that use the inferences. For example, downstream consumers 102 may generate and/or provide prompts of prompts 100B (e.g., portions of ingest data) for processing by the inference models, and may consume inferences generated by the inference models (e.g., in response to the ingest data) and/or output from the downstream processes that use the inferences. The inferences and/or output from the downstream processes may be used by downstream consumers 102 to improve decision-making and/or to automate tasks. For example, downstream consumers 102 may make decisions and/or initiate actions for managing operation of the data processing systems.

Inference model manager 104 may include any number of data processing systems and may manage any number of inference models. Inference model manager 104 may perform tasks relating to management of and/or facilitation of use of the inference models. For example, inference model manager 104 may manage (e.g., facilitate) (i) training processes for the inference models, (ii) preprocessing of prompts for the inference models, (iii) inferencing processes using the inference models (e.g., and the preprocessed prompts), (iv) downstream processes that use inferences obtained using the inference models, and/or (v) distribution of the inferences and/or output derived from the inferences to downstream consumers 102. Refer to the discussion of FIG. 2A for more details regarding operation of inference models.

To increase a likelihood of providing adequate ingest data to the inference models, inference model manager 104 may (i) obtain a prompt for an inference model (e.g., from prompts 100B), (ii) perform an ontology identification process to obtain a query based on the prompt and using ontology definitions, (iii) perform, using the query, a retrieval process for the prompt to obtain context data, and/or (iv) obtain ingest data for the inference models based on the prompt and the context data.

To obtain the query, inference model manager 104 may (i) obtain a representation (e.g., a structured representation) of ontology terms identified as present in the prompt, (ii) use the representation to identify supplemental ontology terms not identified as present in the prompt, and/or (iii) use the identified ontology terms and the supplemental ontology terms to generate the query. Refer to the discussion of FIG. 2C for more information regarding obtaining a query based on a representation.

The retrieval process may include an iterative retrieval process. For example, to perform the iterative retrieval process, inference model manager 104 may (i) analyze context data retrieved during a first retrieval process to identify relevant ontology terms included in the query for which the context data does not meet content criteria, and/or (ii) perform a second retrieval process for the identified relevant ontology terms to retrieve second context data that meets the content criteria. Portions of context data obtained during any of the performed retrieval processes may be packaged as the context data. Refer to the discussion of FIG. 2B for an example of an ontology-based iterative retrieval process.

To facilitate management of operation of the data processing systems using inference models, inference model manager 104 may (i) use the ingest data to obtain a response (e.g., an inference) from an inference model, and/or (ii) use the response to provision desired computer-implemented services (e.g., distribute the response to downstream consumers 102 and/or by provide the response to downstream processes).

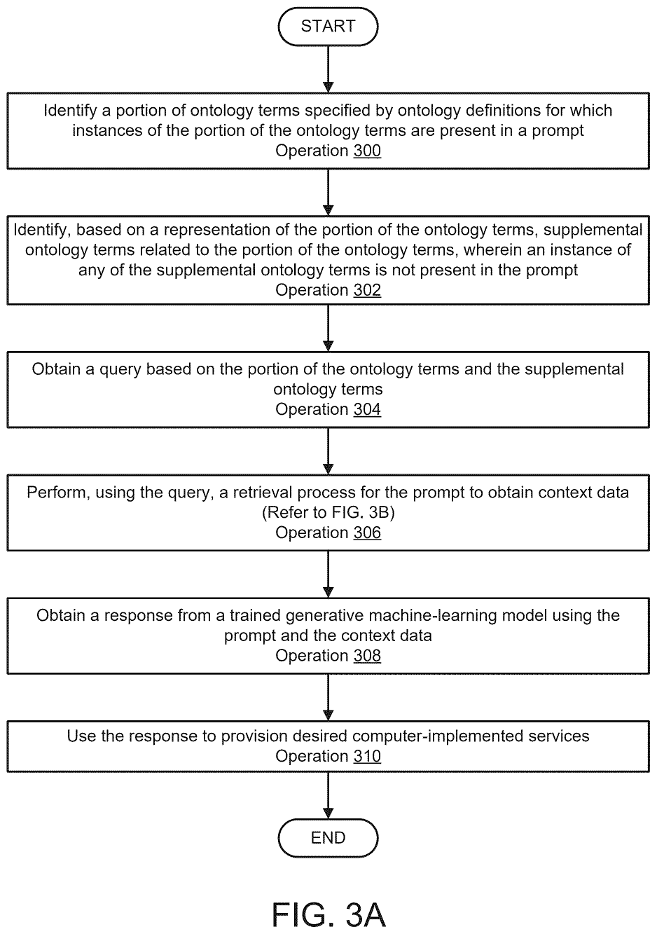

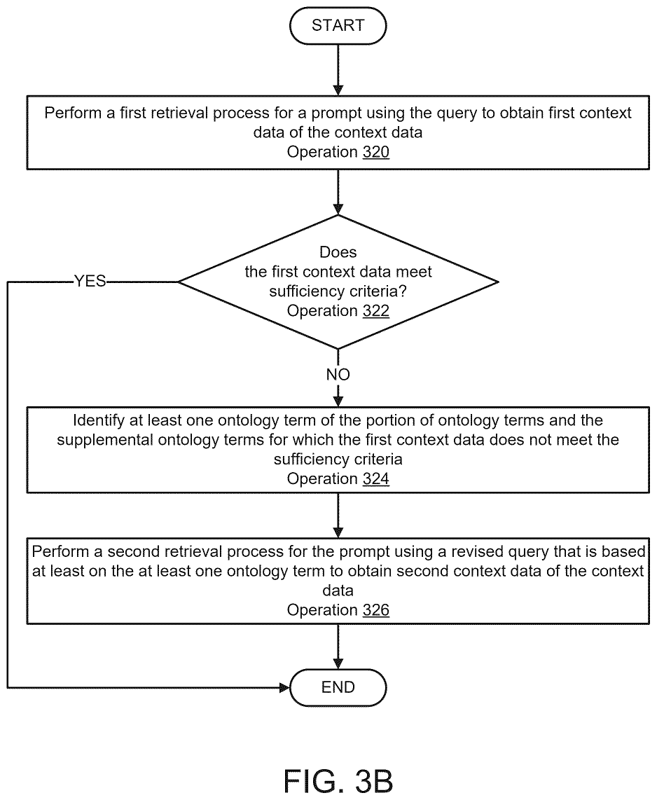

When providing their functionality, any of data sources 100, downstream consumers 102, inference model manager 104, and/or components thereof may perform all, or a portion of the actions and methods illustrated in FIGS. 2A-3B.

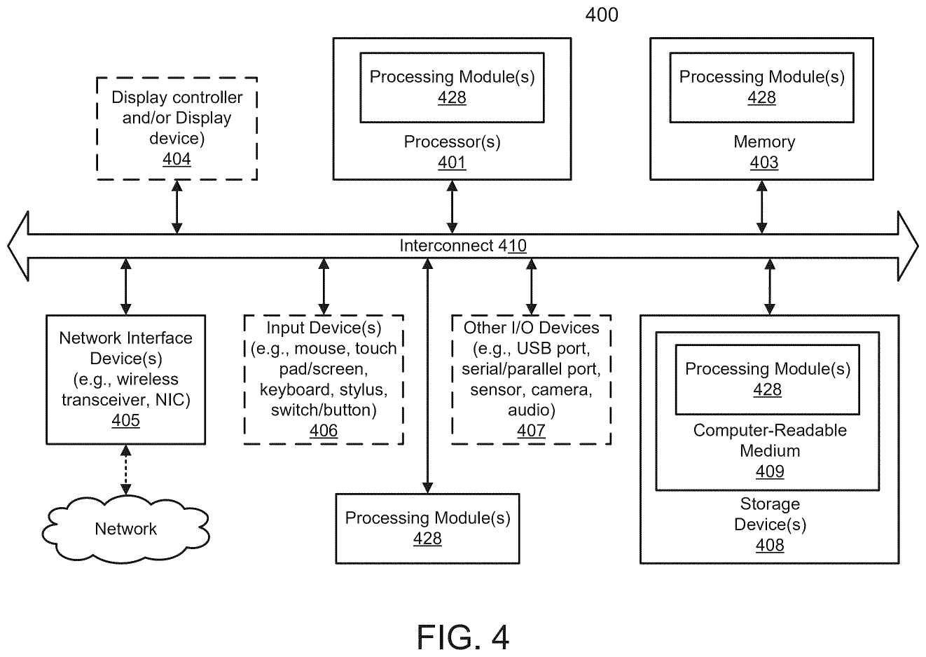

Any of data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In the diagram, flows of data and processing of data are illustrated using different sets of shapes. A first set of shapes (e.g., 200, 201) is used to represent data structures, a second set of shapes (e.g., 202, 212) is used to represent processes performed using and/or that generate data, and a third set of shapes (e.g., 100C) is used to represent sources of data.

Turning to FIG. 2A, a first data flow diagram in accordance with an embodiment is shown. The first data flow diagram may illustrate data used in and data processing performed when facilitating operation of an inference model. For example, the inference model may be used to manage operation of a data processing system.

In the example shown in FIG. 2A, operation of the inference model may include a training process and an inferencing process. The training process may include, for example, initial training of an (untrained) inference model, retraining of an inference model, and/or fine-tuning of an inference model. The inferencing process may include, for example, obtaining inferences using a trained inference model.

To obtain a trained inference model, a management entity (e.g., inference model manager 104) may facilitate performance of training process 202. Training process 202 may include training an untrained inference model defined by untrained model data 200.

Untrained model data 200 may include information relating to model architecture, hyperparameters, and/or other information regarding an untrained inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. For example, the inference model may include a probabilistic model such as a generative machine-learning model (e.g., a large language model).

During training process 202, untrained model data 200 may be updated using training data 201. Training data 201 may be obtained from any number of data sources (e.g., training data sources 100A). For example, if the inference model is being trained to manage security for a data processing system, then the training data may include a corpus of information regarding types of security threats to the data processing system, labeled with actions for responding to the types of security threats (e.g., actions for reconfiguring security settings of the data processing system accordingly). As the inference model is exposed to large numbers of relationships and/or patterns in training data 201, weights and/or other parameters of untrained model data 200 may be modified to obtain trained model data 204.

Trained model data 204 may include inference model data (e.g., information regarding the architecture and/or hyperparameters of the inference model) and/or model parameter values of the inference model (e.g., weights). Trained model data 204 may be used during an inferencing process to generate inferences in response to ingest data, such as ingest data 210.

Ingest data 210 may include a portion of data for which an inference is desired to be obtained. For example, ingest data 210 may include prompt 206 (e.g., of prompts 100B). Prompt 206 may be obtained, for example, from a consumer of inferences and may include instances of ontology terms. To obtain ingest data 210 (e.g., an enhanced version of prompt 206), prompt 206 may undergo prompt preprocessing 208. For example, during prompt preprocessing 208, context data for relevant ontology terms (e.g., ontology terms identified as present in prompt 206 and/or supplemental ontology terms related to the identified ontology terms not identified as present in prompt 206) may be obtained, and ingest data 210 may be generated based on prompt 206 and/or the context data. Refer to the discussion of FIG. 2B for more details regarding prompt preprocessing and/or obtaining ingest data 210.

Ingest data 210, along with trained model data 204, may be provided to inferencing process 212. During inferencing process 212, a trained inference model may be obtained based on information (e.g., node information, weight information, connection information, activation functions, attention mechanisms, etc.) included in trained model data 204. Ingest data 210 may not include labeled data and, thus, an association for ingest data 210 may not be known. During inferencing process 212, the trained inference model (e.g., a trained generative machine-learning model) may read ingest data 210 and respond with an output likely to be associated with the input (e.g., the trained inference model may generate an inference).

For example, ingest data 210 may include information regarding malicious code being executed by a component of a data processing system, and inference 214 may include actions for updating security settings of the data processing system that are likely to mitigate an outcome of the execution of the malicious code according to relationships and/or patterns learned by the inference model during training process 202. Inference 214 may be used to provision computer-implemented services. For example, inference 214 may be provided to downstream process 216, and downstream process 216 may include delivery of inference 214 to a downstream consumer (e.g., as a computer-implemented service), and/or further processing of inference 214.

For example, downstream process 216 may include any type of process for updating operation of the data processing system based on inference 214. For example, downstream process 216 may include a policy enforcement process, wherein security policies for the data processing system are enforced based on information included in inference 214 (e.g., actions, security and/or configuration settings) in order to mitigate outcomes associated with the execution of the malicious code. For example, operation of the data processing system may be updated to prevent access to sensitive data, to prevent network communication via components of the data processing system, and/or to disable operation of portions of components of the data processing system.

Although described with respect to security of the data processing system, it will be appreciated that the inference models may be trained and used to update operation of the data processing system in various capacities without departing from the embodiments disclosed herein. For example, the operation of the data processing system may be updated to improve user experience, to manage failures of components of the data processing system, to improve efficient allocation of resources (e.g., computing and/or power resources), and/or to meet other operational goals for the data processing system.

Thus, using the data flows shown in FIG. 2A, operation of a data processing system may be managed based on inferences generated by trained inference models. By doing so, operation of the data processing systems may be updated timely, and the data processing systems may be more likely to operate in a desired manner.

However, a quality (e.g., usability, reliability) of the inferences generated by the trained inference models may depend on a quality of ingest data to the trained inference models. Therefore, to increase a likelihood of the ingest data being of expected quality (e.g., having adequate, relevant, and appropriately detailed information content), ontology terms relevant to prompts for the trained inference models may be contextualized. Methods for obtaining context data for the prompts may be discussed with respect to FIG. 2B.

Turning to FIG. 2B, a second data flow diagram in accordance with an embodiment is shown. The second data flow diagram may illustrate data used in and data processing performed when obtaining ingest data for an inference model. FIG. 2B may be an example of prompt preprocessing 208 of FIG. 2A.

To obtain the ingest data, context data for prompt 206 may be retrieved from knowledge data sources 100C. Prompt 206 may include a submission to be processed by a trained inference model to facilitate provisioning of desired computer-implemented services by a data processing system. For example, prompt 206 may include information regarding operation of the data processing system. Instances of a portion of ontology terms specified by ontology definitions 224 may be present in prompt 206.

To obtain the context data for prompt 206, a query may be obtained for retrieval process 220. To obtain the query, ontology identification process 219 may be performed. During ontology identification process 219, a prompt (e.g., prompt 206) may be obtained and used to generate a query (e.g., a keyword search query) using ontology definitions 224. Ontology definitions 224 may include, for example, a list (e.g., a table) of ontology terms. As discussed with respect to FIG. 1, the ontology terms may include words and/or phrases that have been designated as having a higher degree of meaning by an operator of the inference model than other words and/or phrases not designated as having the higher degree of meaning by the operator. For example, the ontology terms may include words and/or phrases that have different definitions in different subject areas. Ontology definitions 224 may also include information regarding relationships between elements of the list of ontology terms.

The query may include a list of search terms, search parameters, and/or other information. The query may be derived from terms (e.g., ontology terms) identified as present in prompt 206. For example, ontology terms specified by ontology definitions 224 that are relevant to prompt 206 may be included in the list of search terms of the query. The relevant ontology terms may include ontology terms identified as present in prompt 206 and/or supplemental ontology terms not present in prompt 206 that are related to the identified ontology terms.

The query may be used during retrieval process 220 to obtain context data. By using supplemental ontology terms to obtain the query, appropriately detailed context data (for complex ontology terms that may be included in prompt 206) may be more likely to be retrieved during retrieval process 220. Refer to the discussion of FIG. 2C for more information regarding obtaining the query.

Retrieval process 220 may include any type of process(es) wherein a data source is searched for information using a query. For example, retrieval process 220 may implement information retrieval methods used during any type of retrieval-augmented generation process. During retrieval process 220, the query may be used to search an external data source such as knowledge data sources 100C to identify responsive portions of data stored by the external data source.

As discussed with respect to FIG. 1, knowledge data sources 100C may include a data source designated as a source of true (e.g., trusted, reliable, relevant to a subject area) data by an operator of the inference model. For example, knowledge data sources 100C may include a number of chunks of data that are tagged to associate each of the number of chunks of data with ontology terms (and/or other searchable terms). In other words, the chunks of data may be tagged as related to the ontology terms based on relationships between informational content of the chunks and the ontology terms.

During a first performance of retrieval process 220, a query (e.g., the query generated during ontology identification process 219) may be obtained. Note that during the first performance of retrieval process 220, ontology terms may not be obtained from context data analysis process 222 as indicated by a respective arrow drawn in dashing. The query may be serviced using a deterministic process (e.g., using a trained deterministic inference model and/or any process that returns the same results for repeated servicing of the query). For example, the query may be used to identify portions of data responsive to the search terms (e.g., the relevant ontology terms) using the search parameters and/or instructions included in the query, from knowledge data sources 100C.

The identified portions of data responsive to the query may then be ranked for relevance using a relevance ranking algorithm. Some number (e.g., best hits) of the ranked portions of data may then be selected for use as the context data. However, due to limitations of the relevance ranking algorithm and/or selection criteria, the selected context data may lack context for some terms present in the prompt such as those defined by ontology definitions 224. Therefore, to address these limitations of retrieval process 220, context data analysis process 222 may be performed.

During context data analysis process 222, context data obtained from retrieval process 220 may be analyzed with respect to the relevant ontology terms. For example, first context data obtained from the first retrieval process may be evaluated to determine whether the first content data meets sufficiency criteria. The sufficiency criteria may specify a minimum level of content of context data with respect to the relevant ontology terms. For example, the relevant ontology terms may be obtained from retrieval process 220 (e.g., from the query), and levels of content of the first context related to each of the relevant ontology terms may be identified. The levels of content may be compared to the minimum level of content to identify any relevant ontology terms for which the first context data does not meet the sufficiency criteria.

For example, the minimum level of content may specify, for each ontology term of the relevant ontology terms, (i) a minimum number of words related to the respective ontology terms, (ii) a minimum number of chunks of data in the first context data that are tagged as related to the respective ontology terms, and/or (iii) a combination thereof.

The sufficiency criteria for the context data may be defined by policies. For example, the policies may specify a reduced number of relevant ontology terms that are required to satisfy the minimum level of content, and/or an increased number of terms (e.g., other ontology terms defined by ontology definitions 224, other terms not defined by ontology definitions 224) beyond the relevant ontology terms that are required to satisfy the minimum level of content. Any instances of relevant ontology terms that are not associated with context data satisfying at least the minimum level of content may be identified during context data analysis process 222.

If the first context data meets the sufficiency criteria for all relevant ontology terms, then the first context data may be included in all context data 226. However, if at least one ontology term of the relevant ontology terms may be identified for which the first context data does not meet the sufficiency criteria, then at least a portion of the first context data may be included in all context data 226 (e.g., the portion of the first context data that meet the sufficiency criteria).

In a first example, the at least one ontology term (e.g., shown as “ontology terms” in FIG. 2B) having insufficient context data may be provided to retrieval process 220 to initiate a second (iteration of) retrieval process 220 (e.g., relevant ontology terms for which sufficient context data has been retrieved may not be included in the ontology terms provided to retrieval process 220).

In a second example, the ontology terms provided to retrieval process 220 may include all of the relevant ontology terms, and each of the relevant ontology terms may be tagged (e.g., via updating metadata) to indicate whether sufficient context data has been retrieved for each of the relevant ontology terms. For example, the at least one ontology term may be tagged as being associated with insufficient context data, while other relevant ontology terms may be tagged as being associated with sufficient context data.

Note that the arrow indicating the ontology terms are provided to retrieval process 220 is drawn in dashing to indicate that under some conditions the ontology terms may not be provided to retrieval process 220 (e.g., during a first iteration of retrieval process 220 and/or during subsequent iterations of retrieval process 220 when retrieved context data meets the sufficiency criteria for all relevant ontology terms).

During the second retrieval process, a revised query may be derived using the ontology terms obtained from context data analysis process 222. For example, the revised query may only include relevant ontology terms that are tagged as associated with insufficient context data. The revised query may include a reduced number of ontology terms specified by ontology definitions 224 when compared to a number of ontology terms specified by the query used to perform the first retrieval process. The reduced number of ontology terms may include the at least one ontology term and may exclude a second ontology term of ontology definitions 224 that is a relevant ontology term and for which the first context data meets the sufficiency criteria (e.g., the second ontology term having been included in the query used to perform the first retrieval process).

Consider a security example where a prompt, “Program A is being executed by component C of data processing system D, using resources Q, and is accessing file F”, is provided to retrieval process 220. During the first retrieval process, “A”, “C”, “D”, and “F” may include ontology terms specified by ontology definitions 224. During ontology identification process 219, “A”, “C”, “D”, and “F” may be identified as present in the prompt and supplemental ontology terms “F1” and “F2” (not present in the prompt) may be identified as related to “F”. A list of relevant ontology terms (e.g., “A”, “C”, “D”, “F”, “F1”, “F2”) may be used to obtain the query. Therefore, the query may include six ontology terms specified by ontology definitions 224.

During the first retrieval process, knowledge data sources 100C may return sufficient context data for all relevant ontology terms except “F1”. Therefore, during context data analysis process 222, “F1” may be identified as not being associated with at least the minimum level of content specified by the sufficiency criteria. Therefore, context data analysis process 222 may provide a data package including “F1” (and excluding “A”, “C”, “D”, “F”, “F2” for which sufficient context data has already been obtained) to retrieval process 220, and a second retrieval process may be performed. The second retrieval process may use a revised query that includes one ontology term specified by ontology definitions 224 (e.g., “F1”).

Returning to the second retrieval process, the revised query may be used to retrieve second context data from knowledge data sources 100C. By using the revised query for the second retrieval process, the search algorithm used during retrieval process 220 may be more likely to rank and select sufficient context data for the reduced number of ontology terms included in the revised query compared to using the same query that was used to perform the first retrieval process.

The second context data may be provided to context data analysis process 222, and a determination may be made regarding whether the second context data meets the sufficiency criteria. If the second context data meets the sufficiency criteria, then the second context data may be included in all context data 226. However, if the second context data does not meet the sufficiency criteria, then at least a portion of the second context data may be included in all context data 226, and context data analysis process 222 may be performed to identify ontology terms for which the second context data is insufficient. Iterations of retrieval process 220 and/or context data analysis process 222 may be performed until all context data 226 meets the sufficiency criteria for each relevant ontology term.

All context data 226 may include context data retrieved during any number of iterations of retrieval process 220. All context data 226 may be used, in part, to obtain ingest data 210. For example, ingest data 210 may include all context data 226 (e.g., the first context data and/or the second context data) and/or prompt 206. Ingest data 210 may be provided to an inferencing process so that a response (e.g., an inference) may be obtained using a trained inference model. For example, ingest data 210 may be provided to inferencing process 212 of FIG. 2A.

Returning to the security example, the response obtained from the inference model (e.g., inference 214 in FIG. 2A) during the inferencing process may indicate that program A is likely to include malicious code, and that file “F2” is not expected to be accessed by program A during desired operation of data processing system D. The response may indicate that a security policy for data processing system D should be enforced (e.g., which may occur during downstream process 216 of FIG. 2A).

Turning to FIG. 2C, a third data flow diagram in accordance with an embodiment is shown. The third data flow diagram may illustrate data used in and data processing performed when obtaining a query for an inference model. FIG. 2C may be an example of ontology identification process 219 of FIG. 2B. For example, prompt 206 may include a prompt generated by a user of an inference model.

The query may be obtained based on an analysis of a representation of ontology terms specified by ontology definitions 224. To obtain the representation, representation generation process 242 may be performed. During representation generation process 242, a portion of ontology terms specified by ontology definitions 224 for which instances of the portion of the ontology terms are present in prompt 206 may be identified. For example, prompt 206 may be searched using a search algorithm and a list of (all) ontology terms specified by ontology definitions 224 to identify instances of ontology terms present in prompt 206. The search algorithm may search for and identify terms included in prompt 206 that are similar (e.g., within a threshold) to elements of the list of ontology terms.

The identified ontology terms (e.g., instances of which are present in prompt 206) may be related to other ontology terms specified by ontology definitions 224. For example, ontology definitions 224 may include information regarding relationships between ontology terms (e.g., based on levels of classification of the ontology terms with respect to one another and/or other criteria). During representation generation process 242, related ontology terms may be identified based on the relationships defined by ontology definitions 224. No instances of the related ontology terms may be present in prompt 206; therefore, the related ontology terms may be identified based on the relationships. For example, ontology definitions 224 may include a database that manages all ontology terms and their relationships; therefore, an identified ontology term may be used to query the database, and the query may return any ontology terms related to the identified ontology term.

The identified ontology terms, the related ontology terms, and their relationships may be used to populate a representation. The representation may include a structured representation, such as an acyclic graph. The acyclic graph may include a number of nodes connected by a number of edges. For example, the nodes of the acyclic graph may represent ontology terms and the edges connecting the nodes may represent relationships between the nodes (e.g., the ontology terms).

During representation generation process 242, nodes of the acyclic graph may be established for each of the identified ontology terms and each of the related ontology terms, and edges may be established between the identified ontology terms their corresponding related ontology terms. An example of a representation of ontology terms is shown in FIG. 2D.

Turning to FIG. 2D, a diagram illustrating an example of a representation in accordance with an embodiment is shown. In the example of FIG. 2D, a tree graph is shown with root node 260 representing a common ontology term for the identified ontology terms, “computer”. Root node 260 may be connected to one or more ontology terms identified as present in a prompt (e.g., prompt 206). For example, the prompt “Will my computer warranty cover hardware replacement if I have changed the factory operating system?” may include instances of ontology terms “warranty”, “hardware”, and “operating system”. These identified ontology terms may be used to query a database of ontology definitions (e.g., ontology definitions 224) to identify ontology terms that are related to each of the identified ontology terms.

For example, the ontology term “warranty” may be related to ontology terms “silver” and “gold” (e.g., different types of warranty specific to a manufacturer of the computer), the identified ontology term “hardware” may be related to ontology terms “processor”, “motherboard”, “storage device”, and/or “memory module” (e.g., each with specific product names specific to the manufacturer), and the identified ontology term “factory operating system” may not be related to other ontology terms defined by the ontology definitions. For example, the factory operating system may include a well-known product name.

Thus, during a representation generation process (e.g., representation generation process 242), the identified ontology terms may be established downstream from root node 260 as node 262, node 266, and node 264, via edge 261, edge 263, and edge 265, respectively. The edges may denote relationships regarding levels of classification (e.g., a hierarchical classification) of the ontology terms. Related nodes representing the related ontology terms for may be connected downstream from nodes representing the identified ontology terms.

For example, related node 262A and related node 262B are shown to be connected downstream from node 262 via edge 267 and edge 269, respectively, which may indicate that the related ontology terms represented by related node 262A and related node 262B (e.g., “silver”, “gold”) belong to a lower rank of classification than that of the identified ontology term represented by node 262 (e.g., “warranty”). Similarly, related node 266A, related node 266B, related node 266C, and related node 266D are each shown to be connected downstream to node 266 via edge 271, edge 273, edge 275, and edge 277, respectively. Note that node 264 is not connected to any related nodes, indicating that the ontology definitions do not include any ontology terms related to the identified ontology term represented by node 264 (e.g., “factory operating system”).

The graph shown in FIG. 2D may be analyzed to characterize each of the identified ontology terms based on their complexity. For example, more complex ontology terms may be likely to be connected to more related ontology terms than less complex ontology terms. Thus, a number of related nodes connected to a node representing an identified ontology term may indicate a level of complexity of the identified ontology term. As shown in FIG. 2D, node 262 is connected to two related nodes, node 264 is connected to zero related nodes, and node 266 is connected to four related nodes. Therefore, the identified ontology term “hardware” may be more complex than each of identified ontology term “warranty” and identified ontology term “factory operating system”.

Note that for the purposes of clarity, the representation shown in FIG. 2D is simplified. In practice, a representation of ontology terms may be more complex and may include more nodes (e.g., more related nodes), more edges (e.g., relationships), and more node levels (e.g., levels of classification) than shown in FIG. 2D.

Returning to FIG. 2C, the representation obtained from representation generation process 242 may be provided to analysis process 244. During analysis process 244, supplemental ontology terms may be identified based on the representation. The supplemental ontology terms may be related to the identified ontology terms; however, the supplemental ontology terms may not be present in prompt 206. In other words, the supplemental ontology terms may include at least a portion of the related ontology terms.

As discussed, the supplemental ontology terms may be included in a query for a retrieval process to increase a likelihood of retrieving relevant and appropriately detailed context data. However, if all related ontology terms are included in the query without discrimination, the retrieval process may be more likely to retrieve irrelevant context data and/or larger volumes of context data than necessary; therefore, only a portion of the related ontology terms may be included in the query. Therefore, to determine which portion of the related ontology terms are to be included in the query, the representation may be analyzed.

The representation may be analyzed using any type of graph analysis technique. For example, to analyze an acyclic graph of the identified ontology terms, a first node of the acyclic graph corresponding to an identified ontology term may be identified. Once identified, downstream connections from the first node to its related nodes may be identified and counted to obtain a number of related nodes connected to the first node. The related nodes may correspond to related ontology terms (e.g., ontology terms specified as related to the identified ontology term by ontology definitions 224).

The supplemental ontology terms may be identified based on characterizations of portions of the representation. For example, the first node representing the identified ontology term may be characterized based on its number of related nodes and at least one threshold. A set of thresholds may indicate whether the first node is to be characterized as highly complex, moderately complex, or not complex. The number of related nodes may be compared to the set of thresholds to characterize (e.g., classify) the identified ontology term.

For example, using the example shown in FIG. 2D, a first threshold indicating moderate complexity is 1, and a second threshold indicating high complexity is 3. Therefore, node 264 (“factory operating system”) having zero related nodes and not exceeding the first threshold or the second threshold may be characterized as not complex; node 262 (“warranty”) having two related nodes and exceeding the first threshold but not exceeding the second threshold may be characterized as moderately complex; and node 266 (“hardware”) having four related nodes and exceeding both the first threshold and the second threshold may be characterized as highly complex.

The supplemental ontology terms may be selected based on characterizations of each of the nodes representing identified ontology terms of the acyclic graph. In a first example, if a node is characterized as not complex, then no supplemental ontology terms may be selected. In a second example, if a node is characterized as moderately complex, then all related ontology terms that correspond with the related nodes may be selected as the supplemental ontology terms. In a third example, if a node is characterized as highly complex, then user input may be obtained (e.g., based on the related nodes) to select the supplemental ontology terms. The user of the inference model (e.g., the generator of the prompt) may be presented, using a user interface, with a list of the related ontology terms that correspond with the related nodes (e.g., or at least a portion thereof), and user input obtained via the user interface may indicate selection of the supplemental ontology terms.

Returning to the example of FIG. 2D, based on an analysis of the graph, since node 262 may be characterized as moderately complex, both related ontology terms “silver” and “gold” may be selected as supplemental ontology terms, while no supplemental terms corresponding to node 264 may be selected. However, as node 266 is characterized as highly complex, user input may be obtained to determine which portion of related ontology terms should be selected as the supplemental ontology terms. For example, the user may indicate that warranty information regarding only storage devices for the computer is desired. Thus, by limiting selection of the supplemental ontology terms based on the user input, context data retrieved and used to obtain a response from the inference model may be more likely to be relevant, appropriately detailed yet concise, and/or more likely to be usable by the user.

Returning to FIG. 2C, during analysis process 244, the (selected) supplemental ontology terms and the identified ontology terms may be packaged as relevant ontology terms to prompt 206. For example, the relevant ontology terms may be packaged as a list, and the list of relevant ontology terms may be used to obtain query 246. Query 246 may include a list of search terms including the list of relevant ontology terms, as well as search parameters and/or other information. Query 246 may be used during a retrieval process such as retrieval process 220 of FIG. 2B.

Thus, by selecting supplemental terms based on characterizations of portions of the representation, the supplemental terms included in the query may be selected (e.g., sufficiently limited) to retrieve relevant and appropriately detailed context data without retrieving unnecessarily large volumes of context data that may include irrelevant (e.g., incorrect, and/or otherwise undesired) portions. As discussed, large volumes of context data and/or irrelevant context data included in ingest data to an inference model may negatively impact performance of the inference model and any subsequent management processes.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using data flows shown in FIGS. 2B-2C, a quality of ingest data to inference models may be improved using context data obtained via an iterative retrieval process. The retrieval processes may be more likely to retrieve sufficient, relevant, and/or appropriately detailed context data when context data is retrieved for both identified ontology terms (e.g., instances of which are present in prompts submitted for processing by the inference models) and supplemental ontology terms related to the identified ontology terms (e.g., instances of which are not explicitly present in the prompts). By doing so, inferences obtained based on the ingest data may be more likely to be reliable for managing operation of data processing systems, and the data processing systems may be more likely provide desired computer-implemented services.

Turning to FIG. 3A, a first flow diagram illustrating a first method in accordance with an embodiment is shown. The first flow diagram may illustrate various operations performed while managing operation of a data processing system.

At operation 300, a portion of ontology terms specified by ontology definitions for which instances of the portion of the ontology terms are present in a prompt may be identified.

The portion of ontology terms may be identified by (i) obtaining a notification indicating the portion of the ontology terms, and/or (ii) providing the ontology definitions (e.g., a list of the ontology terms) and the prompt to an algorithm. For example, the algorithm may search the prompt to find words and/or phrases in the prompt that are similar to (e.g., defined by a threshold of similarity) words and/or phrases of the list of the ontology terms. Words and/or phrases in the prompt that are considered similar to (e.g., within the threshold of similarity) words and/or phrases of the list of the ontology terms may be identified as the portion of the ontology terms.

At operation 302, based on a representation of the portion of the ontology terms (e.g., an acyclic graph representing at least ontology terms identified as being present in the prompt), supplemental ontology terms related to the portion of the ontology terms may be identified. An instance of any of the supplemental ontology terms may not be present in the prompt. The supplemental ontology terms may be identified by (i) obtaining a notification indicating the supplemental ontology terms, and/or (ii) obtaining a representation of the portion of the ontology terms, and (iii) analyzing the representation.

The representation of the portion of the ontology terms may be obtained using methods described with respect to representation generation process 242 of FIG. 2C and/or by other methods. For example, the representation of the portion of the ontology terms may include an acyclic graph including a plurality of nodes (e.g., representing the portion of the ontology terms and at least the supplemental ontology terms), connected by a plurality of edges (e.g., representing relationships between the nodes). The supplemental ontology terms may be identified by using methods described with respect to analysis process 244 of FIG. 2C and/or by other methods.

Identifying the supplemental ontology terms may include (i) identifying a first node of the acyclic graph that corresponds to an ontology term of the portion of the ontology terms, (ii) obtaining a number of related nodes of the acyclic graph, the related nodes being connected to the first node, and each of the related nodes corresponding to a related ontology term specified by the ontology definitions for which an instance of which is not present in the prompt, and/or (iii) characterizing the ontology term based on the number of the related nodes and at least one threshold.

The first node of the acyclic graph may be identified by (i) obtaining a notification indicating the first node, and/or (ii) querying metadata of the nodes of the acyclic graph to identify nodes that represent the portion of the ontology terms, and (iii) selecting one of the identified nodes as the first node.

The number of related nodes connected to the first node may be obtained by (i) receiving the number of related nodes (e.g., from another device), (ii) reading the number of related nodes (e.g., from storage), and/or (iii) generating the number of related nodes. For example, the number of related nodes may be generated by (i) querying metadata of the edges of the acyclic graph to identify nodes that are connected to (downstream from) the first node, (ii) obtaining a list of the identified (e.g., related) nodes, and (ii) counting all elements in the list.

The ontology term may be characterized by (i) comparing the number of related nodes connected to the first node to the at least one threshold, and (ii) obtaining a level of complexity for the ontology term represented by the first node based on the comparison(s) to the at least one threshold. The supplemental ontology terms may be identified based on the characterization (the level of complexity) of the ontology term.

In a first example when the number of related nodes exceeds all of the at least one threshold, the ontology term may be characterized as highly complex. Identifying the supplemental ontology terms may include obtaining user input based on the related nodes. The user input may be obtained by (i) receiving the user input (e.g., from another device), (ii) reading the user input (e.g., from storage), and/or (iii) initiating generation of the user input. For example, the generation of the user input may be initiated by (i) obtaining metadata for each of the related nodes, (ii) using the metadata to identify a related ontology term associated with each of the related nodes, (iii) using the identified related ontology terms to generate a list of related ontology terms, (iv) presenting the list of related ontology terms to the user (e.g., via a user interface), and/or (v) accepting the user input via the user interface. The user input may indicate selection of the supplemental ontology terms.

In a second example when the number of related nodes exceeds some but not all thresholds of the at least one threshold, the ontology term may be characterized as moderately complex. Identifying the supplemental ontology terms may include selecting all related ontology terms that correspond with the related nodes as the supplemental ontology terms. The all related ontology terms may be selected by (i) obtaining metadata for each of the related nodes, (ii) using the metadata to identify a related ontology associated with each of the related nodes, and/or (iii) using the identified related ontology terms to generate a list of supplemental ontology terms (e.g., for use in obtaining a query).

In a third example when the number of related nodes does not exceed any thresholds of the at least one threshold, the ontology term may be characterized as not complex. Identifying the supplemental ontology terms may also include selecting no supplemental ontology terms. For example, based on the characterization, no supplemental ontology terms may be selected by obtaining a list of the portion of the ontology terms (e.g., for use in obtaining a query).

At operation 304, a query may be obtained based on the portion of the ontology terms and the supplemental ontology terms. The query may be obtained by (i) receiving the query (e.g., from another device), (ii) reading the query (e.g., from storage), and/or (iii) generating the query. For example, the query may be generated by obtaining a list of relevant ontology terms (e.g., a list of supplemental terms and/or the portion of the ontology terms) for the prompt and using the list of relevant ontology terms as search terms of the query.

At operation 306, a retrieval process may be performed using the query to obtain context data. The retrieval process may be performed by methods described with respect to retrieval process 220 and/or context data analysis process 222 of FIG. 2B and/or by other methods. For example, the retrieval process may be performed by performing all or a portion of operations shown in FIG. 3B.

Turning to FIG. 3B, a second flow diagram illustrating a second method in accordance with an embodiment is shown. The second flow diagram may illustrate various operations performed during a retrieval process for a prompt. FIG. 3B may be an example (e.g., an expansion) of operation 306 of FIG. 3A.

At operation 320, a first retrieval process for a prompt may be performed to obtain first context data of the context data. The first retrieval process may be performed by methods described with respect to retrieval process 220 of FIG. 2B and/or by other methods. For example, the first retrieval process may be performed by (i) obtaining the prompt, (ii) obtaining a query (e.g., see operations 300-304 of FIG. 3A) based on the prompt, (iii) using the query to search a trusted data source to retrieve data responsive to the query, and/or (iv) obtaining the first context data based on at least a portion of the data responsive to the query.

At operation 322, a determination regarding whether the first context data meets sufficiency criteria may be made. The determination may be made by methods described with respect to context data analysis process 222 and/or by other methods (e.g., obtaining a notification indicating whether the first context data meets the sufficiency criteria). The sufficiency criteria may specify a minimum level of content of the first context data with respect to ontology definitions. In other words, different portions of the first context data may be associated with different ontology terms specified by the ontology definitions.

For example, the determination may be made by (i) identifying portions of the first context data associated with each ontology term for which an instance is present in the prompt, (ii) obtaining characteristics for each of the portions of the first context data (e.g., a number of words in each of the portions, a number of data chunks in each of the portions), and/or (iii) comparing the characteristics for each of the portions to a minimum level of content (e.g., a minimum number of words, a minimum number of data chunks). If the characteristics of one or more of the portions do not meet the minimum level of content (e.g., if the number of words in a portion is inferior to the minimum number of words), then the first context data may not meet the sufficiency criteria. Otherwise, if the characteristics of all of the portions meet the minimum level of content, then the first context data may meet the sufficiency criteria.

In a first instance of the determination where the first context data does not meet the sufficiency criteria with respect to the ontology definitions, the method may proceed to operation 324 following operation 322. Otherwise, in a second instance of the determination where the first context data meets the sufficiency criteria, the method may end following operation 322.

At operation 324, at least one ontology term of the portion of the ontology terms and the supplemental ontology terms for which the first context data does not meet the sufficiency criteria may be identified. The at least one ontology term may be identified by methods described with respect to context data analysis process 222 and/or by other methods. For example, the at least one ontology term may be identified by (i) obtaining a notification indicating that the first context data does not meet the sufficiency criteria for the at least one ontology term, or (ii) identifying a portion of the first context data that does not meet the sufficiency criteria (e.g., from operation 322), and (iii) identifying the at least one ontology term associated with the identified portion.

At operation 326, a second retrieval process for the prompt may be performed using a revised query that is based at least on the at least one ontology term to obtain second context data. The second retrieval process may be performed by methods described with respect to FIG. 2A, operation 320, and/or by other methods. For example, the second retrieval process may be performed by (i) obtaining the at least one ontology term, (ii) obtaining (e.g., deriving) a revised query based on the at least one ontology term, (iii) using the revised query to search the trusted data source to retrieve data responsive to the revised query, and/or (iv) obtaining second context data based on at least a portion of the data responsive to the revised query.

As discussed with respect to FIG. 2B, subsequent retrieval processes (third, fourth, etc.) and context data analysis processes may be performed until context data obtained during the subsequent retrieval processes meets the sufficiency criteria with respect to each of the relevant ontology terms.

Returning to FIG. 3A, at operation 308, a response from a trained generative machine-learning model may be obtained using the prompt and the context data. The response may be obtained by (i) receiving the response (e.g., from another device), (ii) reading the response (e.g., from storage), and/or (iii) generating the response. The response may be generated using methods described with respect to FIG. 2A and/or by other methods. For example, the response may be obtained by (i) obtaining (e.g., training) the trained generative machine-learning model, (ii) obtaining (e.g., generating) ingest data for the trained generative machine-learning model, and/or (iii) providing the ingest data to the trained generative machine-learning model for processing.

For example, in the first instance of the determination at operation 322 where the first context data meets the sufficiency criteria, then the ingest data may be obtained by generating a data package that includes the prompt and the first context data; or, in the second instance of the determination at operation 322 where the first context data does not meet the sufficiency criteria and where a combination of the first and second context data does meet the sufficiency criteria, then the ingest data may be obtained by generating a data package that includes the prompt, and the combination of the first and second context data.

At operation 310, the response may be used to provision desired computer-implemented services. The response may be used by (i) providing the response to a downstream consumer as a first portion of the desired computer-implemented services, (ii) providing the response to a downstream process to obtain an output from the downstream process, and/or (iii) using the output from the downstream process to provision a second portion of the desired computer-implemented services.

Using the response may include updating the operation of the data processing system. For example, the response may include information regarding policies that should be enforced in order to increase a likelihood of providing the desired computer-implemented services in view of information included in the prompt, the first context data, and/or the second context data. Refer to the discussion of FIGS. 2A-2B for more details regarding use of the response and/or updating the data processing system.

The method may end following operation 310.

Thus, as illustrated above, embodiments disclosed herein may provide systems and methods for context data retrieval using supplemental ontology terms for prompts submitted to inference models. By retrieving context data for the supplemental ontology terms in addition to retrieving context data for ontology terms identified as present in the prompts, the retrieved context data may be more likely to be appropriately detailed and relevant. The retrieval processes may be performed iteratively to increase a likelihood of obtaining sufficient context data for each relevant ontology term.

By increasing a likelihood of retrieving sufficient, relevant, and appropriately detailed context data, the resulting ingest data may be more likely to facilitate reliable inferencing by the inference models. As a result, the data processing system may be more likely to be updated reliably (e.g., appropriately, timely), and the computer-implemented services provided by the data processing systems may be more likely to be desired computer-implemented services.

Any of the components illustrated in FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein.

Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory.

Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing operation of a data processing system, the method comprising:
identifying a portion of ontology terms specified by ontology definitions for which instances of the portion of the ontology terms are present in a prompt;
identifying, based on a representation of the portion of the ontology terms, supplemental ontology terms related to the portion of the ontology terms, wherein an instance of any of the supplemental ontology terms is not present in the prompt;
obtaining a query based on the portion of the ontology terms and the supplemental ontology terms;
performing, using the query, a retrieval process for the prompt to obtain context data;
obtaining ingest data based on the context data, the ingest data comprising information about execution of malicious code on the data processing system;
obtaining a response from a trained generative machine-learning model using the prompt and the context data, the response indicating a security setting update in response to the execution of the malicious code; and
performing the security setting update on the data processing system to mitigate a security outcome of the execution of the malicious code.

2. The method of claim 1, wherein the prompt is a submission to be processed by the trained generative machine-learning model to facilitate provisioning of the desired computer-implemented services.

3. The method of claim 1, wherein the representation of the portion of the ontology terms comprises an acyclic graph, the acyclic graph comprising a plurality of nodes connected by a plurality of edges, the plurality of nodes representing the portion of the ontology terms and at least the supplemental ontology terms, and the plurality of edges representing relationships between the nodes.

4. The method of claim 3, wherein identifying the supplemental ontology terms comprises:
identifying a first node of the acyclic graph that corresponds to an ontology term of the portion of the ontology terms;
obtaining a number of related nodes of the acyclic graph, the related nodes being connected to the first node, and each of the related nodes corresponding to a related ontology term specified by the ontology definitions for which an instance of which is not present in the prompt; and
characterizing the ontology term based on the number of the related nodes and at least one threshold.

5. The method of claim 4, wherein identifying the supplemental ontology terms further comprises:
obtaining user input based on the related nodes, the user input indicating selection of the supplemental ontology terms.

6. The method of claim 4, identifying the supplemental ontology terms further comprises:
selecting all related ontology terms that correspond with the related nodes as the supplemental ontology terms.

7. The method of claim 4, identifying the supplemental ontology terms further comprises:
selecting no supplemental ontology terms.

8. The method of claim 1, wherein the query is serviced using a deterministic process, the deterministic process returning same results for repeated servicing of the query.

9. The method of claim 1, wherein performing the retrieval process comprises:
performing a first retrieval process for the prompt using the query to obtain first context data of the context data;
making a determination regarding whether the first context data meets sufficiency criteria, the sufficiency criteria specifying a minimum level of content of the first context data with respect to the ontology definitions; and
in a first instance of the determination where the first context data does not meet the sufficiency criteria:
identifying at least one ontology term of the portion of the ontology terms and the supplemental ontology terms for which the first context data does not meet the sufficiency criteria, and
performing a second retrieval process for the prompt using a revised query that is based at least on the at least one ontology term to obtain second context data of the context data.

10. The method of claim 1, wherein the ontology definitions comprises a list of ontology terms comprising the portion of the ontology terms and the supplemental ontology terms, and the ontology terms specified by the ontology definitions are words and/or phrases that have been designated as having a higher degree of meaning by an operator of the trained generative machine-learning model than other words and/or phrases not designated as having the higher degree of meaning by the operator.

11. The method of claim 10, wherein the context data is obtained from a data source designated as a source of true data by the operator of the trained generative machine-learning model, and the data source comprising a number of chunks of data that are each tagged to associate each of the number of chunks of data with the ontology terms.

12. The method of claim 1, wherein using the response to provision the desired computer-implemented services comprises:
updating the operation of the data processing system.

13. A non-transitory machine-readable medium having instructions stored therein, which when executed by a processor, cause the processor to perform operations of a data processing system, the operations comprising:
identifying a portion of ontology terms specified by ontology definitions for which instances of the portion of the ontology terms are present in a prompt;
identifying, based on a representation of the portion of the ontology terms, supplemental ontology terms related to the portion of the ontology terms, wherein an instance of any of the supplemental ontology terms is not present in the prompt;
obtaining a query based on the portion of the ontology terms and the supplemental ontology terms;
performing, using the query, a retrieval process for the prompt to obtain context data;
obtaining ingest data based on the context data, the ingest data comprising information about execution of malicious code on the data processing system;
obtaining a response from a trained generative machine-learning model using the prompt and the context data, the response indicating a security setting update in response to the execution of the malicious code; and
performing the security setting update on the data processing system to mitigate a security outcome of the execution of the malicious code.

14. The non-transitory machine-readable medium of claim 13, wherein the prompt is a submission to be processed by the trained generative machine-learning model to facilitate provisioning of the desired computer-implemented services.

15. The non-transitory machine-readable medium of claim 13, wherein the representation of the portion of the ontology terms comprises an acyclic graph, the acyclic graph comprising a plurality of nodes connected by a plurality of edges, the plurality of nodes representing the portion of the ontology terms and at least the supplemental ontology terms, and the plurality of edges representing relationships between the nodes.

16. The non-transitory machine-readable medium of claim 15, wherein identifying the supplemental ontology terms comprises:
identifying a first node of the acyclic graph that corresponds to an ontology term of the portion of the ontology terms;
obtaining a number of related nodes of the acyclic graph, the related nodes being connected to the first node, and each of the related nodes corresponding to a related ontology term specified by the ontology definitions for which an instance of which is not present in the prompt; and
characterizing the ontology term based on the number of the related nodes and at least one threshold.

17. A system, comprising:
a processor; and
a memory coupled to the processor to store instructions, which when executed by the processor, cause the processor to perform operations of a data processing system, the operations comprising:
identifying a portion of ontology terms specified by ontology definitions for which instances of the portion of the ontology terms are present in a prompt,
identifying, based on a representation of the portion of the ontology terms, supplemental ontology terms related to the portion of the ontology terms, wherein an instance of any of the supplemental ontology terms is not present in the prompt,
obtaining a query based on the portion of the ontology terms and the supplemental ontology terms,
performing, using the query, a retrieval process for the prompt to obtain context data,
obtaining ingest data based on the context data, the ingest data comprising information about execution of malicious code on the data processing system,
obtaining a response from a trained generative machine-learning model using the prompt and the context data, the response indicating a security setting update in response to the execution of the malicious code, and
performing the security setting update on the data processing system to mitigate a security outcome of the execution of the malicious code.

18. The system of claim 17, wherein the prompt is a submission to be processed by the trained generative machine-learning model to facilitate provisioning of the desired computer-implemented services.

19. The system of claim 17, wherein the representation of the portion of the ontology terms comprises an acyclic graph, the acyclic graph comprising a plurality of nodes connected by a plurality of edges, the plurality of nodes representing the portion of the ontology terms and at least the supplemental ontology terms, and the plurality of edges representing relationships between the nodes.

20. The system of claim 19, wherein identifying the supplemental ontology terms comprises:
identifying a first node of the acyclic graph that corresponds to an ontology term of the portion of the ontology terms;
obtaining a number of related nodes of the acyclic graph, the related nodes being connected to the first node, and each of the related nodes corresponding to a related ontology term specified by the ontology definitions for which an instance of which is not present in the prompt; and
characterizing the ontology term based on the number of the related nodes and at least one threshold.
